(19) United States
(12) Patent Application Publication
(10) Pub. No.: US 2020/0166799 A1
(43) Pub. Date: May 28, 2020

(54) TOUCH POLARIZING STRUCTURE AND FLEXIBLE DISPLAY DEVICE

(71) Applicant: Wuhan China Star Optoelectronics Semiconductor Display Technology Co., LTD, Wuhan, Hubei (CN)

(72) Inventor: Hui CHEN, Wuhan, Hubei (CN)

(21) Appl. No.: 16/088,246

(22) PCT Filed: Sep. 4, 2018
(86) PCT No.: PCT/CN2018/104031

§ 371 Date: Sep. 25, 2018

(30) Foreign Application Priority Data
Mar. 21, 2018 (CN) 201810237041.0

(51) Int. Cl. G02F 1/1335; G02F 1/1333

(52) U.S. Cl. CPC G02F 1/133528; G02F 2001/133541; G02F 1/133305; G02F 1/13338

(57) ABSTRACT

The invention provides a touch polarizing structure and flexible display device. The touch polarizing structure comprises a touch layer and a circular polarizer. The touch layer comprises a substrate and a touch electrode layer disposed on a side of the substrate. The circular polarizer comprises a linear polarizer and quarter-wave retarder, or a linear polarizer a half-wave retarder, and a quarter-wave retarder, disposed successively on a side of the substrate away from touch electrode layer and along a direction away from the substrate, the linear polarizer, the quarter-wave retarder and the half-wave retarder each comprise an alignment layer and an LC layer. The touch polarizing structure is thin and reduces the overall thickness of flexible display device under the premise of reducing external light reflection and providing touch display function. The invention reduces the stress of the flexible display device in bending and improves product quality.

### BACKGROUND OF THE INVENTION

### 1. Field of the Invention

The present invention relates to the field of display techniques, and in particular to a touch polarizing structure and flexible display device.

### 2. The Related Arts

The flat panel display device provides many advantages such as thinness, power saving, and radiation-free, and has been widely used. The known flat panel display device mainly comprises a liquid crystal display (LCD) element or an organic light-emitting diode (OLED) element.

Because the OLED display element shows excellent properties of self-luminescence, no backlight source, high contrast, thinness, wide viewing angle, fast response, flexibility for use in a panel, wide operating temperature range, and simple structure and manufacturing process, the OLED display is heralded as the mainstream technology for the next generation of display and favored by major display manufacturers. The OLED display device generally comprises a substrate, an anode disposed on the substrate, a hole injection layer disposed on the anode, a hole transport layer disposed on the hole injection layer, a light-emitting layer disposed on the hole transport layer, an electron transport layer disposed on the light-emitting layer, an electron injection layer disposed on the electron transport layer, and the cathode disposed on the electron injection layer. The light-emitting mechanism is that the semiconductor material and the organic light-emitting material, under driven by an electric field, emit light through the carrier injection and compounding. Specifically, an OLED display device generally employs an indium tin oxide (ITO) electrode and a metal electrode as the anode and the cathode, respectively. Electrons and holes are injected respectively from the cathode and the anode into the electron injection layer and the hole injection layer under a certain voltage. Electrons and holes migrate through the electron transport layer and the hole transport layer respectively to the light-emitting layer, and meet in the light-emitting layer to form excitons and excite the light-emitting molecules, which emit visible light through radiation relaxation.

In a known OLED display, to reduce the external light reflection and improve the color saturation of the display, a circular polarizer is often provided above the OLED display. Also, the OLED display has a touch sensing function and a touch layer needs to be provided above the OLED display. A flexible display requires that the display screen and the film have good flexibility for bending durability and reducing the thickness of the film is an important means to improve the bending performance. To enable the OLED display to perform flexible display, the circular polarizer and the touch layer need to be as thin as possible to reduce the stress that the OLED display is subjected to in bending. The circular polarizers by mass production are about 100 microns in thickness, and the thickness of the touch layer is about 50 microns. To further reduce the thickness of the circular polarizer and touch layer to fit the flexible display, the circular polarizer and the touch layer are combined to make a touch-polarization structure, which becomes a trend. The combination can greatly reduce the total thicknesses of the circular polarizer and touch layer and can be adapted to the future pursuit of greater bending of the flexible display panel.

### SUMMARY OF THE INVENTION

The object of the present invention is to provide a touch polarizing structure, with less thickness and able to effectively reduce the stress experienced by the flexible display device when applied to a flexible display device, to improve the product quality.

Another object of the present invention is to provide a flexible display device, with less thickness and experiencing less stress to improve the product quality.

To achieve the above object, the present invention provides a touch polarizing structure, which comprises: a touch layer and a circular polarizer disposed at a side of the touch layer;

the touch layer comprising a substrate and a touch electrode layer disposed on a side of the substrate;

the circular polarizer comprising: a linear polarizer and a quarter-wave retarder, disposed on a side of the substrate away from the touch electrode layer and disposed successively along a direction away from the substrate; the linear polarizer comprising a first alignment layer and a first liquid crystal (LC) layer, disposed successively along a direction away from the substrate; the quarter-wave retarder comprising a second alignment layer and a second liquid crystal (LC) layer, disposed successively along a direction away from the substrate.

According to a preferred embodiment of the present invention, the circular polarizer further comprises a first transparent optical adhesive layer disposed between the first LC layer and the second alignment layer.

According to a preferred embodiment of the present invention, the circular polarizer further comprises a half-wave retarder disposed between the linear polarizer and the quarter-wave retarder; the half-wave retarder comprises a third alignment layer and a third liquid crystal layer, disposed successively along the direction away from the substrate;

the circular polarizer further comprises a fourth transparent optical adhesive layer disposed between the first LC layer and the third alignment layer, and a fifth transparent optical adhesive layer disposed between the third LC layer and the second alignment layer.

According to a preferred embodiment of the present invention, the touch polarizing structure further comprises a second transparent optical adhesive layer disposed on a side of the circular polarizer away from the touch layer;

the touch layer further comprises a passivation layer disposed on a side of the substrate having the touch electrode layer and the passivation layer covers the touch electrode layer.

According to a preferred embodiment of the present invention, the touch polarizing structure further comprises a third transparent optical adhesive layer disposed on the side of the touch layer away from the circular polarizer.

According to a preferred embodiment of the present invention, the first alignment layer, the first LC layer, the second alignment layer, the second LC layer, the third alignment layer, and the third LC layer are all manufactured by coating.

The present invention also provides a flexible display device, which comprises: a flexible display panel and a touch polarizing structure disposed on a display side of the flexible display panel;

the touch polarizing structure comprising: a touch layer, a circular polarizer disposed at a side of the touch layer, and a second transparent optical adhesive layer disposed on a side of the circular polarizer away from the touch layer; the touch layer comprising a substrate and a touch electrode layer disposed on a side of the substrate; the circular polarizer comprising: a linear polarizer and a quarter-wave retarder, disposed on a side of the substrate away from the touch electrode layer and disposed successively along a direction away from the substrate; the linear polarizer comprising a first alignment layer and a first liquid crystal (LC) layer, disposed successively along a direction away from the substrate; the quarter-wave retarder comprising a second alignment layer and a second liquid crystal (LC) layer, disposed successively along a direction away from the substrate;

the touch polarizing structure being adhered on the display surface of the flexible display panel by the second transparent optical adhesive layer.

According to a preferred embodiment of the present invention, the circular polarizer further comprises a first transparent optical adhesive layer disposed between the first LC layer and the second alignment layer.

According to a preferred embodiment of the present invention, the circular polarizer further comprises a half-wave retarder disposed between the linear polarizer and the quarter-wave retarder; the half-wave retarder comprises a third alignment layer and a third liquid crystal layer, disposed successively along the direction away from the substrate;

the circular polarizer further comprises a fourth transparent optical adhesive layer disposed between the first LC layer and the third alignment layer, and a fifth transparent optical adhesive layer disposed between the third LC layer and the second alignment layer.

According to a preferred embodiment of the present invention, the touch layer further comprises a passivation layer disposed on a side of the substrate having the touch electrode layer and the passivation layer covers the touch electrode layer; the touch polarizing structure further comprises a third transparent optical adhesive layer disposed on the side of the touch layer away from the circular polarizer;

the flexible display device further comprises a package cover plate disposed on a side of the third transparent optical adhesive layer away from the flexible display panel.

The present invention also provides a touch polarizing structure, which comprises: a touch layer and a circular polarizer disposed at a side of the touch layer;

the touch layer comprising a substrate and a touch electrode layer disposed on a side of the substrate;

the circular polarizer comprising: a linear polarizer and a quarter-wave retarder, disposed on a side of the substrate away from the touch electrode layer and disposed successively along a direction away from the substrate; the linear polarizer comprising a first alignment layer and a first liquid crystal (LC) layer; disposed successively along a direction away from the substrate; the quarter-wave retarder comprising a second alignment layer and a second liquid crystal (LC) layer, disposed successively along a direction away from the substrate;

wherein the circular polarizer further comprising a half-wave retarder disposed between the linear polarizer and the quarter-wave retarder; the half-wave retarder comprising a third alignment layer and a third liquid crystal layer, disposed successively along the direction away from the substrate;

the circular polarizer further comprising a fourth transparent optical adhesive layer disposed between the first LC layer and the third alignment layer; and a fifth transparent optical adhesive layer disposed between the third LC layer and the second alignment layer;

wherein the touch polarizing structure further comprising a second transparent optical adhesive layer disposed on a side of the circular polarizer away from the touch layer;

the touch layer further comprising a passivation layer disposed on a side of the substrate having the touch electrode layer and the passivation layer covers the touch electrode layer;

wherein the first alignment layer, the first LC layer, the second alignment layer, the second LC layer, the third alignment layer, and the third LC layer being all manufactured by coating.

The present invention provides the following advantages: the touch polarizing structure provided by the present invention comprises a touch layer and a circular polarizer. The touch layer comprises a substrate and a touch electrode layer disposed on a side of the substrate. The circular polarizer comprises a linear polarizer and quarter-wave retarder, or a linear polarizer, a half-wave retarder, and a quarter-wave retarder, disposed successively on a side of the substrate away from the touch electrode layer and along a direction away from the substrate, the linear polarizer, the quarter-wave retarder and the half-wave retarder each comprise an alignment layer and a liquid crystal layer, and the alignment layer and the liquid crystal layer are manufactured by coating. The touch polarizing structure is disposed on the display surface of the flexible display panel. The thickness of the touch polarizing structure is thin, and the overall thickness of the flexible display device is greatly reduced under the premise of reducing the external light reflection and the touch display function. The invention can effectively reduce the stress of the flexible display device in bending and improve product quality. Also, the transmittance of the circular polarizer made by the coating method can reach over 40% and the degree of polarization can reach 95% or more. In the preparation process, the coating and drying of the liquid crystal layer and the alignment layer can be separately performed, and then be attached to the touch layer to avoid the high temperature of the process of drying the circular polarizer from affecting the electrical conductivity of the touch layer. The flexible display device provided by the invention is thinner, experiences less stress during bending, and achieves high product quality.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of touch polarizing structure provided by a first embodiment of the present invention;

FIG. 2 is a schematic view showing the structure of touch polarizing structure provided by a second embodiment of the present invention;

FIG. 3 is a schematic view showing the structure of touch polarizing structure provided by a third embodiment of the present invention;

FIG. 4 is a schematic view showing the structure of flexible display device provided by a first embodiment of the present invention;

FIG. 5 is a schematic view showing the structure of flexible display device provided by a second embodiment of the present invention;

FIG. 6 is a schematic view showing the structure of flexible display device provided by a third embodiment of the present invention;

### DETAILED DESCRIPTION OF THE PREFERRED EMBODIMENTS

To further illustrate the technical means taken by the present invention and resulted effects, the following detailed description is made in conjunction with the preferred embodiments of the present invention and the accompanying drawings.

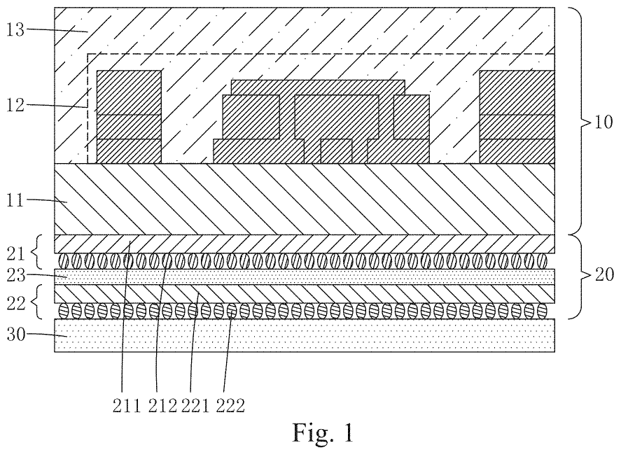

Referring to FIG. 1, FIG. 1 is a schematic view showing the structure of touch polarizing structure provided by a first embodiment of the present invention. The touch polarizing structure provided by the first embodiment of the present invention comprises: a touch layer 10 and a circular polarizer 20 disposed at a side of the touch layer 10;

the touch layer 10 comprising a substrate 11 and a touch electrode layer 12 disposed on a side of the substrate 11;

the circular polarizer 20 comprising: a linear polarizer 21 and a quarter-wave retarder 22, disposed on a side of the substrate 11 away from the touch electrode layer 12 and disposed successively along a direction away from the substrate 11; the linear polarizer 21 comprising a first alignment layer 211 and a first liquid crystal (LC) layer 212, disposed successively along a direction away from the substrate 11; the quarter-wave retarder 22 comprising a second alignment layer 221 and a second liquid crystal (LC) layer 222, disposed successively along a direction away from the substrate 11.

Specifically, the material of the substrate 11 may be selected from the flexible materials commonly used in the touch layer substrates in the prior art, and comprise polymer materials, for example, cycloolefin polymer (COP), polyethylene terephthalate (PET), and so on.

Specifically, the first alignment layer 211 undergoes alignment processing so that the liquid crystal in the first liquid crystal layer 212 forms a specific tilt angle on the first alignment layer 211. Therefore, the linear polarizer 21 formed by the first alignment layer 211 and the first liquid crystal layer 212 has a linear polarization function. The second alignment layer 221 also undergoes an alignment process, so that the liquid crystal in the second liquid crystal layer 222 forms a different tilt angle on the second alignment layer 221 than the liquid crystal in the first liquid crystal layer 212. Therefore, the quarter-wave retarder 22 formed by the second alignment layer 221 and the second liquid crystal layer 222 has the function of optical delay, and the circular polarizer formed by the linear polarizer 21 and the quarter-wave retarder 22 provides a function of preventing light reflection.

Specifically, the circular polarizer 20 further comprises a first transparent optical adhesive layer 23 disposed between the first LC layer 212 and the second alignment layer 221. The first transparent optical adhesive layer 23 is for adhering the quarter-wave retarder 22 to the linear polarizer 21.

Moreover, the first transparent optical adhesive layer 23 may be a pressure sensitive adhesive (PSA).

Specifically, the first alignment layer 211, the first LC layer 212, the second alignment layer 221, and the second LC layer 222 are all manufactured by coating.

Specifically, the total thickness of the linear polarizer 21 and the quarter-wave retarder 22 is smaller than the total thicknesses of the linear polarizer and the quarter-wave retarder in the conventional non-LC coated circular polarizer. Preferably, the total thicknesses of the linear polarizer 21 and the quarter-wave retarder 22 is less than 4 micrometers (μm).

Specifically, the thickness of the first transparent optical adhesive layer 23, the thickness of the first liquid crystal layer 212, and the thickness of the second liquid crystal layer 222 are all on the same order of magnitude. Preferably, the thickness of the first transparent optical adhesive layer 23 is less than 1 μm; that is, preferably, the thickness of the circular polarizer 20 is less than 5 μm.

Specifically, the touch layer 10 further comprises a passivation layer 13 disposed on a side of the substrate 11 disposed with the touch electrode layer 12 and the passivation layer 13 covers the touch electrode layer 12 for protection.

Specifically, the touch polarizing structure further comprises a second transparent optical adhesive layer 30 disposed on a side of the circular polarizer 20 away from the touch layer 10, When the touch polarizing structure is applied to a flexible display device, the second transparent optical adhesive layer 30 is used to adhere the touch polarizing structure to the display surface of the flexible display panel, thereby preventing the external light from being reflected on the display device and realizing touch display functions.

Moreover, the second transparent optical adhesive layer 30 may be a pressure sensitive adhesive.

It should be noted that, in the present invention, because the circular polarizer 20 is directly disposed on the side of the substrate 11 of the touch layer 10 away from the touch electrode layer 12, that is, the circular polarizer 20 and the touch layer 10 share a single substrate 11, the inside of the circular polarizer 20 does not need to provide a supporting structure. Therefore, the overall thickness of the touch polarizing structure is greatly reduced. Also, because the first alignment layer 211, the first liquid crystal layer 212, the second alignment layer 221, and the second liquid crystal layer 222 are all made by coating, the thickness of each layer can be easily controlled to be very thin. In addition, the thickness of the first transparent optical adhesive layer 23 made of pressure sensitive adhesive can also be easily controlled to be thin. As a result, the thickness of the circular polarizer 20 is very thin, which further reduces the overall thickness of the touch polarizing structure, so that the total thickness of the touch polarizing structure of the present invention can be in the range of 50 to 60 micrometers (μm), Compared to the separate circular polarizer and touch layer in the prior art, the thickness of the touch polarizing structure of the present invention can be reduced by about 150 μm. Compared with the prior art wherein a circular polarizer and a touch layer are combined to form a touch polarizing structure, and the thickness of the touch polarizing structure of the present invention can be reduced by about 15 μm. Furthermore, when the touch polarizing structure is applied to a flexible display device, the overall thickness of the flexible display device is reduced, the stress of the flexible display device is greatly reduced in bending and the product quality is improved. Also, the optical transmittance of the circular polarizer 20 obtained by coating the first alignment layer 211, the first liquid crystal layer 212, the second alignment layer 221, and the second liquid crystal layer 222 can reach 40%. The degree of polarization reaches 95% or more. Moreover, the coating and drying of the first alignment layer 211, the first liquid crystal layer 212, the second alignment layer 221, and the second liquid crystal layer 222 can be separately performed during the preparation process, and then adhered to the control layer 10 to prevent the high temperature of the process of drying the circular polarizer 20 from affecting the electrical properties of the touch layer 10.

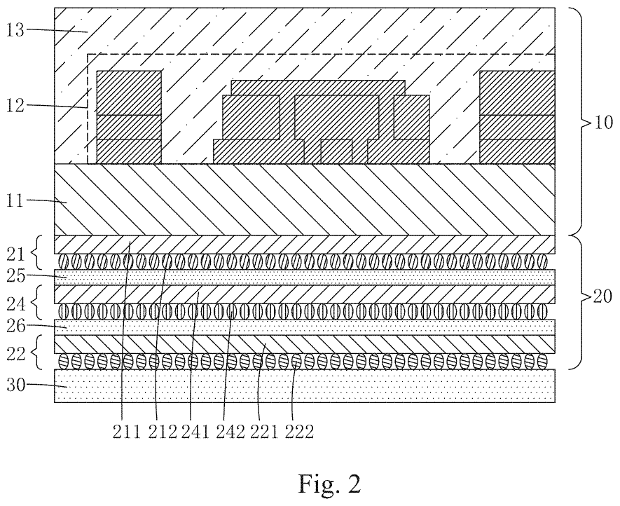

Referring to FIG. 2, FIG. 2 is a schematic view showing the structure of touch polarizing structure provided by a second embodiment of the present invention. The second embodiment differs from the first embodiment in that the circular polarizer 20 further comprises a half-wave retarder 24 disposed between the linear polarizer 21 and the quarter-wave retarder 22; the half-wave retarder 24 comprises a third alignment layer 241 and a third liquid crystal layer 242, disposed successively along the direction away from the substrate 11.

Specifically, the third alignment layer 241 undergoes alignment processing so that the liquid crystal in the third liquid crystal layer 242 forms a specific tilt angle on the third alignment layer 241. Therefore, the half-wave retarder 24 formed by the third alignment layer 241 and the third liquid crystal layer 242 has the function of optical delay, and the circular polarizer 20 formed by the linear polarizer 21, the quarter-wave retarder 22 and the half-wave retarder 24 provides a function of preventing light reflection.

Furthermore, the circular polarizer 20 further comprises a fourth transparent optical adhesive layer 25 disposed between the first liquid crystal layer 212 and the third alignment layer 241, and a fifth transparent optical adhesive layer 26 disposed between the third liquid crystal layer 242 and the second alignment layer 221. The fourth transparent optical adhesive layer 25 is used for adhering the linear polarizer 21 to the half-wave retarder 24, and the fifth transparent optical adhesive layer 26 is used for adhering the quarter-wave retarder 22 to the half-wave retarder 24.

Moreover, the fourth transparent optical adhesive layer 25 and the fifth transparent optical adhesive layer 26 may be a pressure sensitive adhesive.

Specifically, the third alignment layer 241 and the third liquid crystal layer 242 are also manufactured by coating.

Specifically, the thickness of the fourth transparent optical adhesive layer 25, the thickness of the fifth transparent optical adhesive layer 26, the thickness of the first liquid crystal layer 212, the thickness of the second liquid crystal layer 222, and the thickness of the third liquid crystal layer 242 are all at the same order of magnitude. Preferably, the thickness of the fourth transparent optical adhesive layer 25 and the thickness of the fifth transparent optical adhesive layer 26 are all less than 1 μm.

The remaining of the second embodiment is the same as the first embodiment, and the details will not be repeated here.

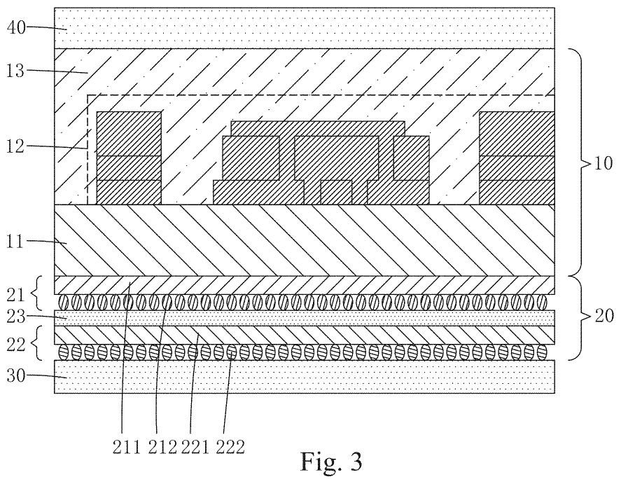

Referring to FIG. 3, FIG. 3 is a schematic view showing the structure of touch polarizing structure provided by a third embodiment of the present invention. The third embodiment differs from the first embodiment in that the touch polarizing structure further comprises a third transparent optical adhesive layer 40 disposed on the side of the touch layer 10 away from the circular polarizer 20. The remaining of the third embodiment is the same as the first embodiment, and the details will not be repeated here.

Specifically, the third transparent optical adhesive layer 40 is a pressure sensitive adhesive.

It should be noted that the third transparent optical adhesive layer 40 is used for bonding a package cover plate after the touch polarizing structure is disposed on the flexible display panel of the flexible display device to complete the packaging of the flexible display device. The package cover plate can be a flexible encapsulating layer or a glass cover plate. The use of the third transparent optical adhesive layer 40 can replace the ultraviolet (UV) curable glue used for adhering the package cover plate in the prior art, thus eliminating the need to separately form the UV curable adhesive and curing the UV curable adhesive by UV light after packaging, which saves the production process and improves the product yield.

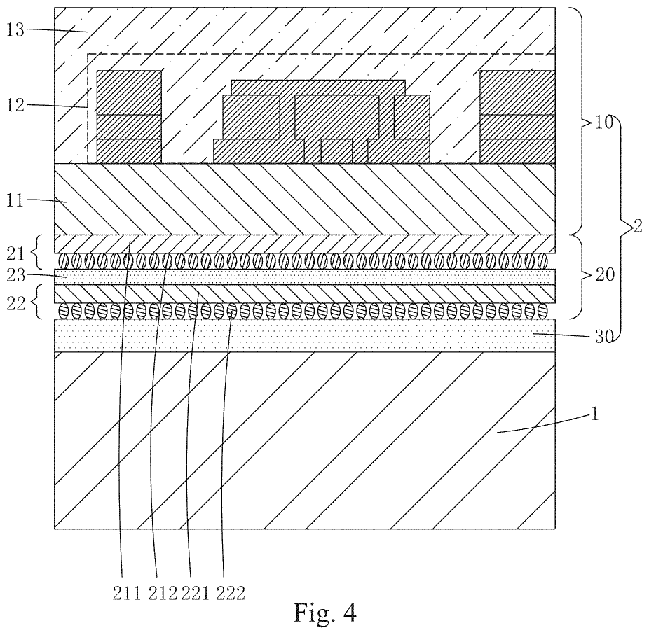

Based on the same concept, the present invention also provides a flexible display device, Referring to FIG. 4, FIG. 4 is a schematic view showing the structure of flexible display device provided by a first embodiment of the present invention. The first embodiment of the flexible display device comprises a flexible display panel 1 and a touch polarizing structure 2 disposed on a display side of the flexible display panel 1;

touch polarizing structure 2 comprising: a touch layer 10, a circular polarizer 20 disposed at a side of the touch layer 10, and a second transparent optical adhesive layer 30 disposed on a side of the circular polarizer 20 away from the touch layer 10; the touch layer 10 comprising a substrate 11 and a touch electrode layer 12 disposed on a side of the substrate 11; the circular polarizer 20 comprising: a linear polarizer 21 and a quarter-wave retarder 22, disposed on a side of the substrate 11 away from the touch electrode layer 12 and disposed successively along a direction away from the substrate 11; the linear polarizer 21 comprising a first alignment layer 211 and a first liquid crystal layer 212, disposed successively along a direction away from the substrate 11; the quarter-wave retarder 22 comprising a second alignment layer 221 and a second liquid crystal layer 222, disposed successively along a direction away from the substrate 11;

the touch polarizing structure 2 being adhered on the display surface of the flexible display panel 1 by the second transparent optical adhesive layer 30.

Specifically, the flexible display panel 1 is a flexible OLED display panel. Clearly, the flexible display panel 1 may also be any other type of flexible display panel to be provided with a circular polarization layer and a touch layer. For example, the flexible display panel 1 may also be a flexible liquid crystal display panel.

Specifically, the material of the substrate 11 may be selected from the flexible materials commonly used in the touch layer substrates in the prior art, and comprise polymer materials, for example, cycloolefin polymer (COP), polyethylene terephthalate (PET), and so on.

Specifically, the first alignment layer 211 undergoes alignment processing so that the liquid crystal in the first liquid crystal layer 212 forms a specific tilt angle on the first alignment layer 211. Therefore, the linear polarizer 21 formed by the first alignment layer 211 and the first liquid crystal layer 212 has a linear polarization function. The second alignment layer 221 also undergoes an alignment process, so that the liquid crystal in the second liquid crystal layer 222 forms a different tilt angle on the second alignment layer 221 than the liquid crystal in the first liquid crystal layer 212. Therefore, the quarter-wave retarder 22 formed by the second alignment layer 221 and the second liquid crystal layer 222 has the function of optical delay, and the circular polarizer formed by the linear polarizer 21 and the quarter-wave retarder 22 provides a function of preventing light reflection.

Specifically, the circular polarizer 20 further comprises a first transparent optical adhesive layer 23 disposed between the first LC layer 212 and the second alignment layer 221. The first transparent optical adhesive layer 23 is for adhering the quarter-wave retarder 22 to the linear polarizer 21.

Moreover, the first transparent optical adhesive layer 23 may be a pressure sensitive adhesive.

Specifically, the first alignment layer 211, the first LC layer 212, the second alignment layer 221, and the second LC layer 222 are all manufactured by coating.

Specifically, the total thickness of the linear polarizer 21 and the quarter-wave retarder 22 is smaller than the total thicknesses of the linear polarizer and the quarter-wave retarder in the conventional non-LC coated circular polarizer. Preferably, the total thicknesses of the linear polarizer 21 and the quarter-wave retarder 22 is less than 4 μm.

Specifically, the thickness of the first transparent optical adhesive layer 23, the thickness of the first liquid crystal layer 212, and the thickness of the second liquid crystal layer 222 are all on the same order of magnitude. Preferably; the thickness of the first transparent optical adhesive layer 23 is less than 1 μm; that is, preferably; the thickness of the circular polarizer 20 is less than 5 μm.

Specifically, the touch layer 10 further comprises a passivation layer 13 disposed on a side of the substrate 11 disposed with the touch electrode layer 12 and the passivation layer 13 covers the touch electrode layer 12 for protection.

Specifically, the second transparent optical adhesive layer 30 may be a pressure sensitive adhesive.

It should be noted that, in the present invention, because the circular polarizer 20 is directly disposed on the side of the substrate 11 of the touch layer 10 away from the touch electrode layer 12, that is, the circular polarizer 20 and the touch layer 10 share a single substrate 11, the inside of the circular polarizer 20 does not need to provide a supporting structure. Therefore, the overall thickness of the touch polarizing structure is greatly reduced. Also; because the first alignment layer 211, the first liquid crystal layer 212; the second alignment layer 221, and the second liquid crystal layer 222 are all made by coating, the thickness of each layer can be easily controlled to be very thin. In addition, the thickness of the first transparent optical adhesive layer 23 made of pressure sensitive adhesive can also be easily controlled to be thin. As a result, the thickness of the circular polarizer 20 is very thin, which further reduces the overall thickness of the touch polarizing structure; so that the total thickness of the touch polarizing structure of the present invention can be in the range of 50 to 60 micrometers (μm), Compared to the separate circular polarizer and touch layer in the prior art, the thickness of the touch polarizing structure of the present invention can be reduced by about 150 μm. Compared with the prior art wherein a circular polarizer and a touch layer are combined to form a touch polarizing structure, and the thickness of the touch polarizing structure of the present invention can be reduced by about 15 μm. Furthermore, when the touch polarizing structure is applied to a flexible display device, the overall thickness of the flexible display device is reduced, the stress of the flexible display device is greatly reduced in bending and the product quality is improved. Also, the optical transmittance of the circular polarizer 20 obtained by coating the first alignment layer 211, the first liquid crystal layer 212, the second alignment layer 221, and the second liquid crystal layer 222 can reach 40%. The degree of polarization reaches 95% or more. Moreover, the coating and drying of the first alignment layer 211, the first liquid crystal layer 212, the second alignment layer 221, and the second liquid crystal layer 222 can be separately performed during the preparation process, and then adhered to the control layer 10 to prevent the high temperature of the process of drying the circular polarizer 20 from affecting the electrical properties of the touch layer 10.

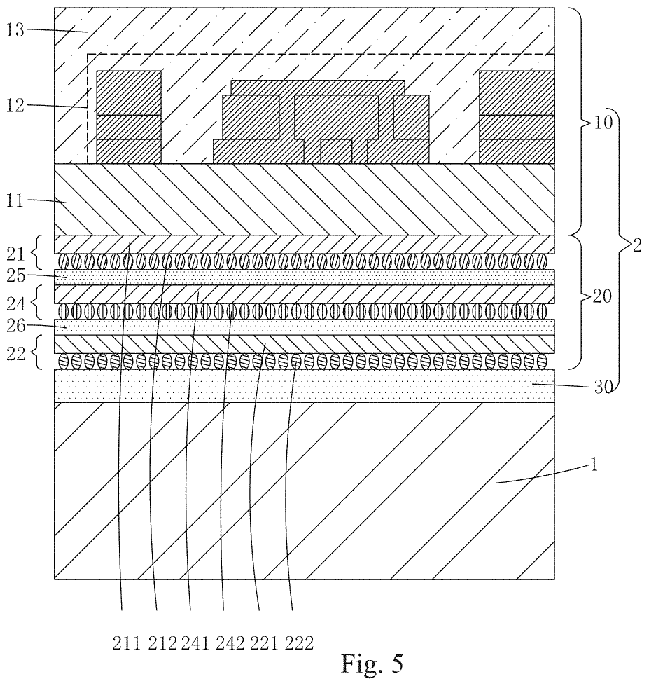

Referring to FIG. 5, FIG. 5 is a schematic view showing the structure of flexible display device provided by a second embodiment of the present invention. The second embodiment differs from the first embodiment in that the circular polarizer 20 further comprises a half-wave retarder 24 disposed between the linear polarizer 21 and the quarter-wave retarder 22; the half-wave retarder 24 comprises a third alignment layer 241 and a third liquid crystal layer 242, disposed successively along the direction away from the substrate 11.

Specifically, the third alignment layer 241 undergoes alignment processing so that the liquid crystal in the third liquid crystal layer 242 forms a specific tilt angle on the third alignment layer 241. Therefore, the half-wave retarder 24 formed by the third alignment layer 241 and the third liquid crystal layer 242 has the function of optical delay, and the circular polarizer 20 formed by the linear polarizer 21, the quarter-wave retarder 22 and the half-wave retarder 24 provides a function of preventing light reflection.

Furthermore, the circular polarizer 20 further comprises a fourth transparent optical adhesive layer 25 disposed between the first liquid crystal layer 212 and the third alignment layer 241, and a fifth transparent optical adhesive layer 26 disposed between the third liquid crystal layer 242 and the second alignment layer 221. The fourth transparent optical adhesive layer 25 is used for adhering the linear polarizer 21 to the half-wave retarder 24, and the fifth transparent optical adhesive layer 26 is used for adhering the quarter-wave retarder 22 to the half-wave retarder 24.

Moreover, the fourth transparent optical adhesive layer 25 and the fifth transparent optical adhesive layer 26 may be a pressure sensitive adhesive.

Specifically, the third alignment layer 241 and the third liquid crystal layer 242 are also manufactured by coating.

Specifically, the thickness of the fourth transparent optical adhesive layer 25, the thickness of the fifth transparent optical adhesive layer 26, the thickness of the first liquid crystal layer 212, the thickness of the second liquid crystal layer 222, and the thickness of the third liquid crystal layer 242 are all at the same order of magnitude. Preferably, the thickness of the fourth transparent optical adhesive layer 25 and the thickness of the fifth transparent optical adhesive layer 26 are all less than 1 μm.

The remaining of the second embodiment is the same as the first embodiment, and the details will not be repeated here.

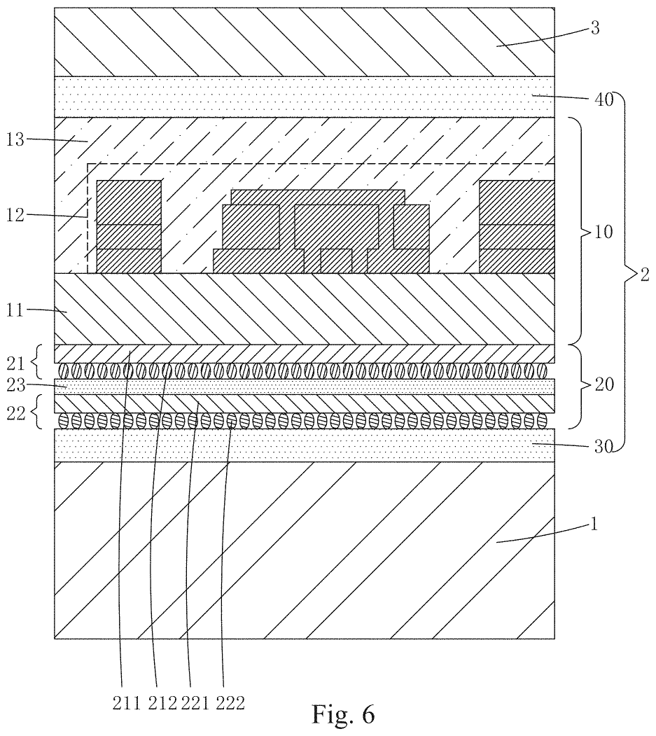

Referring to FIG. 6, FIG. 6 is a schematic view showing the structure of flexible display device provided by a third embodiment of the present invention. The third embodiment differs from the first embodiment in that the touch polarizing structure further comprises a third transparent optical adhesive layer 40 disposed on the side of the touch layer 10 away from the circular polarizer 20. The flexible display device further comprises a package cover plate 3 disposed on a side of the third transparent optical adhesive 40 away from the flexible display panel 1. The remaining of the third embodiment is the same as the first embodiment, and the details will not be repeated here.

Specifically, the package cover plate 3 can be a flexible encapsulating layer or a glass cover plate, and the third transparent optical adhesive layer 40 is a pressure sensitive adhesive.

It should be noted that the use of the third transparent optical adhesive layer 40 can replace the ultraviolet (UV) curable glue used for adhering the package cover plate in the prior art, thus eliminating the need to separately form the UV curable adhesive and curing the UV curable adhesive by UV light after packaging, which saves the production process and improves the product yield.

In summary, the touch polarizing structure provided by the present invention comprises a touch layer and a circular polarizer. The touch layer comprises a substrate and a touch electrode layer disposed on a side of the substrate. The circular polarizer comprises a linear polarizer and quarter-wave retarder, or a linear polarizer, a half-wave retarder, and a quarter-wave retarder, disposed successively on a side of the substrate away from the touch electrode layer and along a direction away from the substrate, the linear polarizer, the quarter-wave retarder and the half-wave retarder each comprise an alignment layer and a liquid crystal layer, and the alignment layer and the liquid crystal layer are manufactured by coating. The touch polarizing structure is disposed on the display surface of the flexible display panel. The thickness of the touch polarizing structure is thin, and the overall thickness of the flexible display device is greatly reduced under the premise of reducing the external light reflection and the touch display function. The invention can effectively reduce the stress of the flexible display device in bending and improve product quality. The flexible display device is thinner and experiences less stress in bending, and therefore, provides better product quality.

It should be noted that in the present disclosure the terms, such as, first, second are only for distinguishing an entity or operation from another entity or operation, and does not imply any specific relation or order between the entities or operations. Also, the terms “comprises”, “include”, and other similar variations, do not exclude the inclusion of other non-listed elements. Without further restrictions, the expression “comprises a . . . ” does not exclude other identical elements from presence besides the listed elements.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A touch polarizing structure; comprising: a touch layer and a circular polarizer disposed at a side of the touch layer;
the touch layer comprising a substrate and a touch electrode layer disposed on a side of the substrate;
the circular polarizer comprising: a linear polarizer and a quarter-wave retarder, disposed on a side of the substrate away from the touch electrode layer and disposed successively along a direction away from the substrate; the linear polarizer comprising a first alignment layer and a first liquid crystal (LC) layer, disposed successively along a direction away from the substrate; the quarter-wave retarder comprising a second alignment layer and a second liquid crystal (LC) layer; disposed successively along a direction away from the substrate.

2. The touch polarizing structure as claimed in claim 1, wherein the circular polarizer further comprises a first transparent optical adhesive layer disposed between the first LC layer and the second alignment layer.

3. The touch polarizing structure as claimed in claim 1, wherein the circular polarizer further comprises a half-wave retarder disposed between the linear polarizer and the quarter-wave retarder; the half-wave retarder comprises a third alignment layer and a third LC layer, disposed successively along the direction away from the substrate;
the circular polarizer further comprises a fourth transparent optical adhesive layer disposed between the first LC layer and the third alignment layer, and a fifth transparent optical adhesive layer disposed between the third LC layer and the second alignment layer.

4. The touch polarizing structure as claimed in claim 1, wherein the touch polarizing structure further comprises a second transparent optical adhesive layer disposed on a side of the circular polarizer away from the touch layer;
the touch layer further comprises a passivation layer disposed on a side of the substrate having the touch electrode layer and the passivation layer covers the touch electrode layer.

5. The touch polarizing structure as claimed in claim 4, wherein the touch polarizing structure further comprises a third transparent optical adhesive layer disposed on the side of the touch layer away from the circular polarizer.

6. The touch polarizing structure as claimed in claim 3, wherein the first alignment layer, the first LC layer, the second alignment layer, the second LC layer, the third alignment layer, and the third LC layer are all manufactured by coating.

7. A flexible display device, comprising: a flexible display panel and a touch polarizing structure disposed on a display side of the flexible display panel;
the touch polarizing structure comprising: a touch layer, a circular polarizer disposed at a side of the touch layer, and a second transparent optical adhesive layer disposed on a side of the circular polarizer away from the touch layer; the touch layer comprising a substrate and a touch electrode layer disposed on a side of the substrate; the circular polarizer comprising: a linear polarizer and a quarter-wave retarder, disposed on a side of the substrate away from the touch electrode layer and disposed successively along a direction away from the substrate; the linear polarizer comprising a first alignment layer and a first liquid crystal (LC) layer, disposed successively along a direction away from the substrate; the quarter-wave retarder comprising a second alignment layer and a second liquid crystal (LC) layer, disposed successively along a direction away from the substrate;
the touch polarizing structure being adhered on the display surface of the flexible display panel by the second transparent optical adhesive layer.

8. The flexible display device as claimed in claim 7, wherein the circular polarizer further comprises a first transparent optical adhesive layer disposed between the first LC layer and the second alignment layer.

9. The flexible display device as claimed in claim 7, wherein the circular polarizer further comprises a half-wave retarder disposed between the linear polarizer and the quarter-wave retarder; the half-wave retarder comprises a third alignment layer and a third LC layer, disposed successively along the direction away from the substrate;
the circular polarizer further comprises a fourth transparent optical adhesive layer disposed between the first LC layer and the third alignment layer, and a fifth transparent optical adhesive layer disposed between the third LC layer and the second alignment layer.

10. The flexible display device as claimed in claim 7, wherein the touch layer further comprises a passivation layer disposed on a side of the substrate having the touch electrode layer and the passivation layer covers the touch electrode layer; the touch polarizing structure further comprises a third transparent optical adhesive layer disposed on the side of the touch layer away from the circular polarizer;
the flexible display device further comprises a package cover plate disposed on a side of the third transparent optical adhesive layer away from the flexible display panel.

11. A touch polarizing structure, comprising: a touch layer and a circular polarizer disposed at a side of the touch layer;
the touch layer comprising a substrate and a touch electrode layer disposed on a side of the substrate;
the circular polarizer comprising: a linear polarizer and a quarter-wave retarder, disposed on a side of the substrate away from the touch electrode layer and disposed successively along a direction away from the substrate; the linear polarizer comprising a first alignment layer and a first liquid crystal (LC) layer; disposed successively along a direction away from the substrate; the quarter-wave retarder comprising a second alignment layer and a second liquid crystal (LC) layer, disposed successively along a direction away from the substrate;
wherein the circular polarizer further comprising a half-wave retarder disposed between the linear polarizer and the quarter-wave retarder; the half-wave retarder comprising a third alignment layer and a third liquid crystal layer, disposed successively along the direction away from the substrate;
the circular polarizer further comprising a fourth transparent optical adhesive layer disposed between the first LC layer and the third alignment layer, and a fifth transparent optical adhesive layer disposed between the third LC layer and the second alignment layer;
wherein the touch polarizing structure further comprising a second transparent optical adhesive layer disposed on a side of the circular polarizer away from the touch layer;
the touch layer further comprising a passivation layer disposed on a side of the substrate having the touch electrode layer and the passivation layer covers the touch electrode layer;
wherein the first alignment layer, the first LC layer, the second alignment layer, the second LC layer, the third alignment layer, and the third LC layer being all manufactured by coating.
